(19) United States
(12) Patent Application Publication
(10) Pub. No.: US 2011/0004420 A1
(43) Pub. Date: Jan. 6, 2011

(54) Method for Identification of an Electric Drive System to be Modeled as a Multimass Oscillator and/or for Detection of Damage in Bearings and/or on Elements Susceptible to Wear and a Corresponding Device and Electric Drive System

(75) Inventors: Sebastian Villwock, Rosstal (DE); Jose Mario Pacas, Freudenberg (DE)

Correspondence Address: KREMBLAS & FOSTER, 7632 SLATE RIDGE BOULEVARD, REYNOLDSBURG, OH, 43068, US

(73) Assignee: BAUMULLER NURNBERG GMBH, Nurnberg (DE)

(21) Appl. No.: 12/828,818

(22) Filed: Jul. 1, 2010

(30) Foreign Application Priority Data
Jul. 6, 2009 (EP) 09 164 675.2

(51) Int. Cl. G06F 19/00; G01P 3/00; G06G 7/48

(52) U.S. Cl. 702/34; 702/145; 703/7

(57) ABSTRACT

A method for identification of an electric drive system to be modeled as a multimass oscillator and/or for detection of damages in bearings and/or on elements susceptible to wear in an electric drive system, whereby a mechanical angular velocity of the electric drive system is determined in a sensorless method as part of the present method, and signal processing is performed on the basis of correlograms and/or Welch's method, using the mechanical angular velocity determined without a sensor, such that the frequency response of the mechanics of the electric drive system is determined as part of the signal processing, the data thereof being used for determination of at least one parameter of the electric drive system.

The invention relates to a method for identification of an electric drive system to be modeled as a multimass oscillator and/or for detection of damage in bearings and/or on elements susceptible to wear in an electric drive system as well as a respective device and a corresponding electric drive system.

The mechanical system of an electric drive can often be modeled in practice as a multimass oscillator. The drive system is identified in the sense of modeling, and then a parameterization of the regulators and/or other components of the drive system is performed on the basis of the model thereby identified. The modeling is important for the process of starting operation of the drive system. In addition, it is expedient to perform condition monitoring of electric drive systems. Within the scope of such a condition monitoring, detection of bearing damage and/or damage to elements of the drive system that are susceptible to wear should be performed in particular.

Mechanical sensors are used in previous methods concerned with modeling in and/or with detection of damage in electric drive systems. Such sensors are used to determine the mechanical angular velocity or the mechanical rotor position angle of the drive system in order to be able to perform the required calculations on the basis of these variables, which are determined by sensory testing.

It is basically already known that the angular velocity of electric machines may be determined merely on the basis of the measurement of the terminal variables of the machine. However, all of the identification methods for electric drive systems which are known so far and are used accordingly in the diagnosis of damage in drive systems are methods which rely on sensors. This means that a separate component is required to perform these methods using a rotary transducer, so that this increases the cost on the one hand, while on the other hand the expense of assembly and evaluation is increased and furthermore additional sources of error may occur.

The object of the present invention is thus to provide a method for identification of an electric drive system, which is to be modeled as a multimass oscillator and/or for detection of damage in bearings and/or on elements in an electric drive system which are susceptible to wear, which is thus improved in this regard.

To achieve this object, a method of this type is proposed according to the present invention, and is characterized in that a mechanical angular velocity of the electric drive system is determined without a sensor within the scope of the method, and signal processing is performed on the basis of correlograms and/or Welch's method based on the mechanical angular velocity determined without a sensor, such that the frequency response of the mechanics of the electric drive system is determined within the scope of the signal processing, its data being used to determine at least one parameter of the electric drive system.

The inventive method thus combines specific identification methods for multimass oscillators and/or detection of bearing damage and other damage in electric drive systems which have been known in the past only on the basis of the use of special sensors, by determining the mechanical angular velocity without the use of sensors. Thus, according to the present invention, a sensorless identification of a multimass oscillator and/or a sensorless diagnosis of bearing damage and/or damage to elements of the drive system that are susceptible to wear is made possible by means of a special signal processing based on correlogram methods and/or Welch's method. Therefore, reliable methods of system identification, which were previously known only in the form of methods relying on sensors, can now also be implemented without the use of sensors. The present invention thus makes a valuable contribution toward automated startup of electric drive systems and also for diagnosis and maintenance of such electric drives. Welch's method is used to estimate the signal strength with respect to the frequency with noise abatement. Welch's method is based on the concept of using periodograms to transfer a signal from the time frame to the frequency domain.

Sensorless methods for determining the mechanical angular velocity, which do not require a mechanical sensor for measuring the angular velocity and/or the rotor position angle, yield reliable results above a minimal stator frequency. The existence of such a minimal stator frequency as a condition is always present in the inventive method based on the aforementioned evaluation by means of correlograms and/or Welch's method including the determination of the frequency response of the mechanics of the electric drive system. This allows an inventive combination of sensorless determination of the angular velocity with this specific signal processing in any conceivable application case.

The identification process itself is divided into two steps, where first the frequency response of the mechanics is calculated with the help of Welch's method or the correlogram method on the basis of measured time signals, while the plant parameters are determined after signal processing. As a rule, the determination of the parameters of the electric drive system is performed in such a way that a complete model of the system is obtained as a result. In addition, however, it is also conceivable within the scope of the present invention for only specific system parameters and/or a restricted number of parameters of the drive system to be determined.

Details of the signal processing as well as the possibility of determination of the plant parameters using frequency data can be obtained, for example, from the dissertation by S. Villwock “Identification Methods for Automated Startup and Condition Monitoring of Electric Drives,” University of Siegen, 2007.

The mechanical angular velocity can be determined according to the present invention in a sensorless method on the basis of electric terminal variables, which are or will be measured, in particular the electric current and/or voltage of the drive system. The exclusive use of terminal variables such as the current and optionally the voltage offers the advantage that this method relies on variables which are usually measured anyway or are easily measured or are already available. No complex or separate additional sensors are required.

The electric drive system may be stimulated with pseudo-stochastic binary signals as test signals as part of the determination of the frequency response. If the drive were not energized with pseudo-stochastic binary signals, as proposed here, but instead with its resonant frequency, for example, then damage extending even to destruction of the installation might occur. Accordingly, it is advantageous to perform the system energization without using harmonic functions but instead using pseudo-stochastic binary signals, which may be generated by a test signal generator, for example.

Within the context of the determination of the frequency response, test signals for energizing the electric drive system may be determined by means of a test signal generator and/or test signals for energizing the electric drive system may be determined by means of a test signal generator, which is parameterizable, in particular for optimization of the identification results.

Thus, on the one hand, signals may be generated by a test signal generator in a targeted manner and used for energizing the electric drive system, but on the other hand, it is advantageous to design the test signal generator in such a way that there are sufficient possibilities for parameterizing the test signal and/or the generator. The identification result can be improved and/or optimized through suitable adjustment of the test signal because changes in the test signal have a great influence on the results of the identification procedure.

Within the scope of determination of the frequency response, the torque-forming components of the stator current and/or the rotational speed of the motor may be processed as signals. For the digital signal processing, which is performed in the inventive method, suitable computer equipment may expediently be provided, such that this computer equipment is part of the electric drive system and may optionally fulfill other tasks in the drive system and/or is connected to the drive system as separate computer facilities via a data line. The signal generation may optionally also be performed by means of one or more such computer systems. Essentially, however, it is also conceivable for the signal generation and/or signal energization and the digital signal processing to be performed by different items of equipment and in particular even separately from the remaining system control. Processing of the torque-forming components of the stator current and processing of the rotational speed of the motor as signals are suggested because these are variables which are either being recorded already anyway as the standard in a drive regulating unit and/or which can be determined without any great effort.

According to the invention, the at least one parameter of the electric drive system and in particular all parameters of the electric drive system can be determined by means of a Levenberg-Marquardt method. The numerical method of Levenberg and Marquardt is based on a combination of a Gauss-Newton method with a regularizing technique, which forces descending function values. An optimization algorithm for solving nonlinear fitting equation problems is created in this way.

Additional details concerning the use of this method as part of a error diagnosis in particular and condition monitoring of machine elements that are susceptible to wear such as damaged roller bearings can be obtained from the aforementioned dissertation by Mr. Villwock, Dr. Eng. The electric drive system may be modeled as a two-mass oscillator, a three-mass oscillator or a multimass oscillator. Modeling as a two-mass oscillator is often sufficient, but in complex systems, modeling as a three-mass oscillator, a four-mass oscillator, etc. may be expedient or necessary.

The inventive method may be used as part of error diagnosis and/or condition monitoring of bearings and/or elements of the electric drive system that are susceptible to wear. The detection of bearing damage and/or of damage to system elements that are subject to wear in general may thus be integrated in a targeted manner into an error diagnosis method and/or a continuous and/or periodic or manually initiated condition monitoring.

For detection of damage and/or bearing defects as part of error diagnosis and/or condition monitoring of bearings and/or elements that are susceptible to wear, another frequency response measurement may be performed and/or a check for broad-band damage in particular due to soiling and/or defective lubrication and/or a check for singular damage in particular to an external and/or internal raceway of a bearing may be performed. For error diagnosis and/or condition monitoring of machine elements susceptible to wear, such as damaged roller bearings, the frequency response measurement may thus be used again. The check of the signals recorded may thus take place in such a way that there may be an examination for broad-band damage, which may occur due to soiling or inadequate lubrication of installation elements, among other things, as well as due to singular damage, e.g., to the internal and/or external raceway of a bearing.

Characteristic error frequencies may be checked in order to check for broad-band damage, the spectrum of measurement signals may be checked for unpredictable changes over a wide frequency range and/or to check for singular defects. Thus, first of all, a search for changes of an unpredictable and/or regulable nature may be conducted over a large frequency range in the spectrum to discover any broad-band damage to elements that are susceptible to wear. However and/or in addition, it singular defects are to be checked and/or discovered, it is advisable to search for unusual features in the range of characteristic error frequencies, for example, by using corresponding programs of a computer system to perform the signal processing as part of the inventive method. The frequency response analysis method for detection of bearing damage can be verified experimentally as being very suitable on various bearing defects. The characteristic error frequencies can be determined by using approximation formulas into which only the number of rolling elements of the respective bearing and the mechanical angular velocity of the drive are included in addition to constants.

The invention thus allows detection of bearing defects, other installation damage as well as a system identification, in which measurement of the mechanical angular velocity with the help of a rotary transducer is completely unnecessary. Instead of that, the angular velocity is determined, for example, on the basis of the measured machine currents without requiring any mechanical sensor. The inventive combination of the specific signal processing on the basis of Welch's method as well as correlograms for determining the frequency response of the mechanics and then using the numerical method of Levenberg and Marquardt for determining the plant parameters using the sensorless determination of the mechanical angular velocity allows a reliable and very secure identification of the multimass system and furthermore a detection of bearing damage without requiring any complex sensor systems.

In addition, the invention relates to a device which is designed for identification of an electric drive system to be modeled as a multimass oscillator and/or for detection of damages in bearings and/or on the elements susceptible to wear in an electric drive system, in particular as described above, and which is characterized in that it has means for sensorless determination of a mechanical angular velocity of the electric drive system and is designed for signal processing based on correlograms and/or Welch's method based on the mechanical angular velocity determined in a sensorless process, whereby the device is designed within the scope of signal processing for determination of the frequency response of the mechanics of the electric drive system and for using the data of the frequency response to determine at least one parameter of the electric drive system.

To do so, the device expediently comprises suitable equipment for generating signals, such as a test signal generator to energize the electric drive system and to calculate the frequency response from the measured time signals. The calculation and signal processing are performed by means of at least one computer unit of the device in which program means suitable for this purpose are provided, allowing in particular an automatic and optionally also a manually triggered data acquisition and/or evaluation with the help of the aforementioned numerical method. Therefore the torque-forming components of the stator current and the rotational speed of the motor are supplied to the computer unit as signals to be processed. If necessary, it is also conceivable for the computer unit to actively request these values for signal processing and then to receive them over corresponding data lines, e.g., from the control system of the electric drive system. However, the computer system for digital signal evaluation of the inventive device may of course also be part of a plant control system, which is present anyway, and/or a computer system in a plant and may access the data available there accordingly.

In addition, the present invention relates to an electric drive system, which is designed with a device as described above and/or is designed to have means for performing a method as described in the introduction.

Additional advantages, features and details of the invention are derived on the basis of the following exemplary embodiment as well as from the drawing, in which:

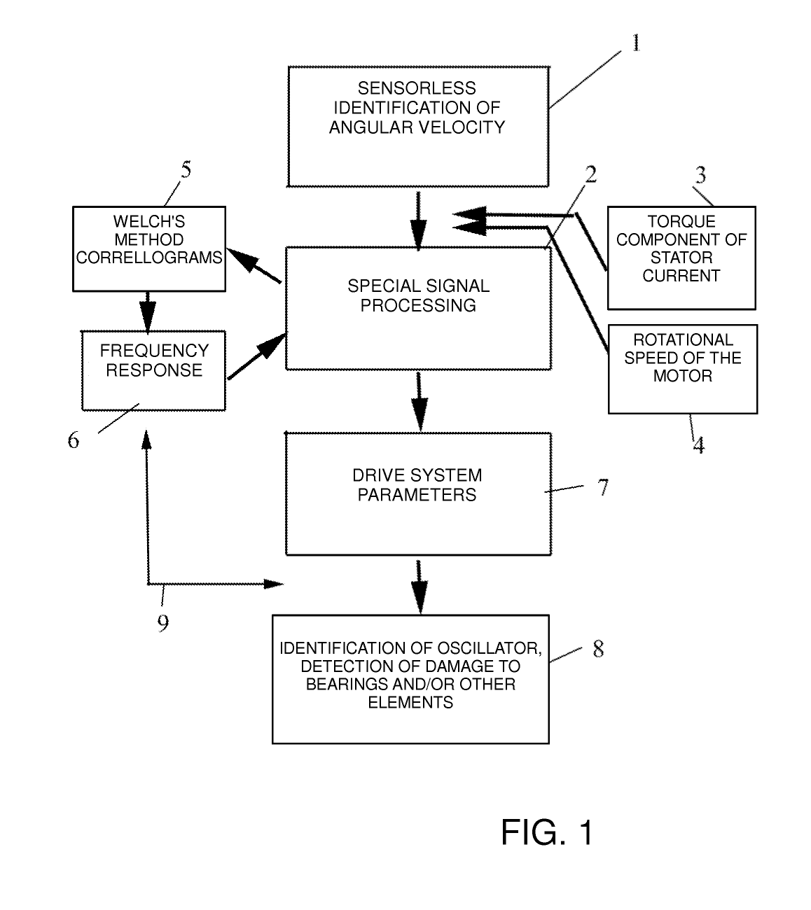

FIG. 1 shows a schematic diagram of the sequence of an inventive method for identification of an electric drive system to be modeled as a multimass oscillator and/or for detection of damages in bearings and/or in elements that are susceptible to wear in an electric drive system.

The invention is characterized in that according to box 1 in FIG. 1, the identification of the mechanical angular velocity is performed in a sensorless process, i.e., without the use of a separate sensor. Instead of that, only terminal variables of the machine are used. For example, the torque-forming components of the stator current according to box 3 and the estimated rotational speed of the motor according to box 4 are used, as shown here, and are sent as signals to be processed for the special signal processing according to box 2. The specific signal processing according to the present invention is based on the use of Welch's method and/or the correlogram method according to box 5, on the basis of which the frequency response of the mechanics (cf. box 6) is calculated from the measured time signals.

The digital signal processing is then followed by the determination of the parameters of the drive system according to box 7, where all the relevant system parameters and/or all the model parameters are expediently determined. In the preferred exemplary embodiment, the system parameters are determined by using the frequency response data with the help of the numerical method of Levenberg and Marquardt. On this basis, detection of bearing damages and other plant damages is also possible in addition to identification of the multimass system according to box 8. In general, an error diagnosis and/or condition monitoring for machine elements that are susceptible to wear may be performed. As indicated by the double arrow 9, a frequency response measurement is again performed according to the present invention for diagnosis of bearing defects and similar damages.

It is no longer necessary within the scope of the present invention to measure the mechanical angular velocity with the help of separate sensors. The angular velocity is determined merely on the basis of the measuring machine currents and/or voltages without any mechanical sensor to thereby arrive at a sensorless identification of the multimass oscillator and/or a sensorless diagnosis of bearing damages.

### LIST OF REFERENCE NUMERALS

1 Box
2 Box
3 Box
4 Box
5 Box
6 Box
7 Box
8 Box
9 Double arrow

1. A method for identification of an electric drive system to be modeled as a multimass oscillator or for detection of damages in bearings or on elements susceptible to wear in an electric drive system, the method comprising: determining a mechanical angular velocity of the electric drive system in a sensorless method as part of the present method, and performing signal processing on the basis of correlograms or Welch's method, using the mechanical angular velocity determined without a sensor, such that the frequency response of the mechanics of the electric drive system is determined as part of the signal processing, the data thereof being used for determination of at least one parameter of the electric drive system.

2. The method as recited in claim 1 and further comprising determining the mechanical angular velocity on the basis of measured electric terminal variables or those that are to be measured, the measured electric terminal variables being the electric current or voltage or the drive system.

3. The method as recited in claim 2 wherein the electric drive system is energized with pseudo-stochastic binary signals as the test signals.

4. The method as recited claim 2 wherein test signals for energization of the electric drive system are determined as part of the determination of the frequency response by means of a test signal generator or test signals for energizing the electric drive system are determined by means of a parameterizable test signal generator for optimizing the result of the identification.

5. The method as recited in claim 2 wherein torque-forming components of stator current or rotational speed of the motor are processed as signals as part of the determination of the frequency response.

6. The method as recited in claim 2 wherein all the parameters of the drive system, are determined by means of a Levenberg-Marquardt method.

7. The method as recited in claim 2 wherein the electric drive system is modeled as a two-mass oscillator or a three-mass oscillator or a multimass oscillator.

8. The method as recited in claim 2 wherein the method is used as part of an error diagnosis or a condition monitoring of bearings or elements of the electric drive system that are susceptible to wear.

9. The method as recited in claim 8, wherein another frequency response measurement is performed for detection of damages as part of an error diagnosis or condition monitoring of bearings or elements susceptible to wear or a check for broad-band damages is performed as part of an error diagnosis or a condition monitoring of bearings or elements susceptible to wear, checking for damage due to soiling or inadequate lubrication or for singular damages to an external or internal raceway of a bearing in particular.

10. The method as recited in claim 9, wherein a spectrum of measurement signals is checked for unpredictable changes over a wide frequency range in order to check for broad-band damages, or for checking for singular defects, characteristic error frequencies are checked.

11. A device designed for identification of an electric drive system to be modeled as a multimass oscillator and/or for detection of damages in bearings or on elements susceptible to wear in an electric drive system, wherein the device comprises means for sensorless determination of a mechanical angular velocity of the electric drive system and for signal processing based on correlograms or Welch's method by means of the mechanical angular velocity determined in a sensorless method, whereby the device is part of the signal processing for determination of the frequency response of the mechanics of the electric drive system and for use of the data of the frequency response to determine at least one parameter of the electric drive system.

12. (canceled)
